(19) United States
(12) Patent Application Publication
(10) Pub. No.: US 2011/0036164 A1
(43) Pub. Date: Feb. 17, 2011

(54) LEVEL SENSING CONTROLLER AND METHOD

(75) Inventor: Roger D. Burdi, Ada, MI (US)

Correspondence Address: BARNES & THORNBURG LLP, P.O. Box 2786, CHICAGO, IL, 60690-2786, US

(73) Assignee: TOUCHSENSOR TECHNOLOGIES, LLC, Wheaton, IL (US)

(21) Appl. No.: 12/844,512

(22) Filed: Jul. 27, 2010

Related U.S. Application Data
(60) Provisional application No. 61/228,812, filed on Jul. 27, 2009.

(51) Int. Cl. G01F 23/00

(52) U.S. Cl. 73/303

(57) ABSTRACT

An apparatus for controlling a pump or other device includes first and second proximity sensors adapted to sense level of a fluid or powder in a vessel and a control circuit adapted to receive and process the sensor outputs and output one or more control signals to control a controlled device. The first and second sensor locations can be interchanged without affecting performance of the apparatus.

### CROSS-REFERENCE TO RELATED APPLICATIONS

This application claims priority from and incorporates by reference the disclosure of U.S. Provisional Patent Application No. 61/228,812, filed on Jul. 27, 2009.

### BACKGROUND OF THE INVENTION

A simple sump pump controller acts to turn a pump on and off based on input from a single level sensor located at a predetermined level in the sump. When the sensor detects the proximity of water, indicating that the water level within the sump is at or above the level of the sensor, the controller turns the pump on. When the sensor no longer detects the proximity of water, indicating that the water level has fallen below the level of the sensor, the controller turns the pump off. One drawback to such a controller is that it lacks substantial hysteresis. As such, it can cause the pump to cycle on and off rapidly, particularly when fluid is flowing into the sump rapidly. Such rapid cycling could cause the pump motor to overheat and fail, among other undesirable consequences.

An improved sump pump controller includes first and second level sensors located at first and second predetermined levels in the sump, with the first sensor being located at a higher level than the second sensor. The controller turns the pump on when both the upper and lower sensors detect the proximity of water, indicating that the water level is at or above the level of the first (upper) sensor and, therefore, at or above the level of the second (lower) sensor. Once the controller has turned the pump on, it disregards the state of the first sensor and allows the pump to remain on until the second (lower) sensor no longer detects proximity of water, indicating that the water level has fallen below the level of the second sensor.

A drawback to this form of improved controller is that it does not work properly if the first and second level sensor locations are reversed. With the first sensor located below the second sensor, the controller turns the pump on when the water is at or above the level of both the first (lower in this example) sensor and the second (upper in this example) sensor. Because the controller disregards the state of the first sensor in determining when to turn the pump off, the controller turns the pump off when the water level falls below the level of the second sensor, even though the water level may still be well above the level of the first sensor. With the water level still above the level of the first sensor, the controller turns the pump on again as soon as the water level again rises to or above the level of the second sensor. Accordingly, the controller cycles the pump on and off as the fluid level fluctuates about the level of the second sensor. As such, with the first and second sensor locations reversed, this form of improved controller works in essentially the same way as the simple controller described above.

### SUMMARY OF THE DISCLOSURE

This disclosure is directed to a level sensing controller including first and second proximity sensors, control logic, and a power switch. Each of the first and second proximity sensors detects, and outputs a signal indicative of, the presence or absence of water or another aqueous or non-aqueous fluid or object in proximity to the sensor. The control logic (which could be embodied as a microprocessor and/or other suitable circuitry) receives and processes the signals from the sensors according to predetermined criteria, as discussed further below. When the predetermined criteria are met, the control logic outputs to the power switch a control signal indicating that the power switch should be turned on or off. The power switch (which could be embodied as a triac or other suitable form of power switch) responds to the control signal by turning power to a connected pump on or off. The level sensing controller can thereby enable and disable operation of a pump connected thereto by selectively turning power to the pump on and off.

The control logic requires that both the first and second sensors detect the presence or proximity of water at substantially the same time as a condition of enabling operation of the pump. The control logic also requires that neither of the first and second sensors detects the presence or proximity of water at substantially the same time as a condition of disabling operation of the pump. Because both the first and second proximity sensors must detect the presence or proximity of water as a condition of enabling operation of the pump and both must not detect the presence of water as a condition of disabling the pump, it is irrelevant whether the first sensor is located above the second sensor or vice versa. Accordingly, the level sensing controller could be installed in nearly any orientation from horizontal to vertical, as desired, without impacting its general operability.

The control logic could require that additional criteria be met as conditions of enabling or disabling operation of the pump. For example, the control logic could require that both the first and second sensors substantially simultaneously detect the presence or proximity of water for at least a predetermined amount of time before it enables operation of the pump. Similarly, the control logic could require that neither of the first and second sensors detects the presence or proximity of water substantially simultaneously for at least a predetermined amount of time before it disables operation of the pump. Such a delay feature could prevent sloshing water from causing the controller to spuriously enable or disable operation of the pump.

The first and second sensors could be embodied as any form of sensor suitable for detecting the presence or proximity of water. For example, the sensors could be embodied as field effect sensors, each having first and second electrodes and an active component in close proximity to the electrodes. The first electrode could be embodied as a conductive pad and the second electrode could at least partially surround the first electrode. The active component could take the form of a TS100 ASIC bearing an integral control circuit marketed by TouchSensor Technologies, LLC of Wheaton, Ill. The TS-100 ASIC includes an integral control circuit for use with such electrode structures. The theory of operation of such sensors is described in, for example, U.S. Pat. No. 6,320,282, the contents of which are incorporated herein by reference. The sensors could be embodied in other forms and/or types, as well.

The first and second sensors, control logic, and power switch could be disposed on a single substrate sealed within a liquid-tight housing made of plastic or other suitable material. The substrate and housing could, but need not, be oblong to enable the sensors to be efficiently spaced apart from each other. Alternatively, any or all of the first and second sensors, control logic, and power switch could be located on separate substrates in the same or separate housings. For example, the first sensor and the control logic could be located on a first substrate in a first housing and the second sensor could be located on a second substrate in a second housing and electrically connected to the control logic via a cable or tether extending between the first housing and second housing. Alternatively, the second sensor could be wirelessly coupled to the control logic.

Additional sensors could be coupled to the control logic as redundant inputs or for use in implementing other functions. For example, one or more additional sensors could be configured to detect the presence of water at one or more higher-than-normal levels within a sump. The control logic could use this information to start a second pump and/or to trigger an alarm indicating, for example, that the water level in the sump is higher than normal or that the sump has overflowed.

The level sensing controller could include other components, for example, a power supply and a thermal overload protection device.

The level sensing controller is not limited to use with fluids and pumps. For example, it could be used to detect and control the level of other substances in a tank, vessel, or other volume by enabling and disabling devices appropriate for conveying such substances. For example, the level sensing controller could be used to sense the level of a powder or other material (for example, aggregate) in a hopper and to selectively enable and disable a conveyor for moving the powder or aggregate out of the tank or to open and close a weir to allow the powder or material to flow out of the hopper. Where level sensing controller 10 is used with a fluid or powder, the fluid or powder should have a sufficiently high dielectric constant to be detectable by the sensors.

The level sensing controller also can be used in conjunction with high voltage contactors to control industrial pumps running higher multiphase motors such as those used in municipal sewer systems, treatment plants and manufacturing plants.

### BRIEF DESCRIPTION OF THE DRAWINGS

FIG. 1 is a perspective view of a system including a sump, a sump pump, and a level sensing controller;

FIG. 2 is a schematic layout drawing of a circuit board bearing components of a level sensing controller;

FIG. 3 is an exploded perspective view of a level sensing controller;

FIG. 4 is a schematic diagram of the control logic and power control section of a level sensing controller; and

FIG. 5 is a perspective view of a portion of the exterior of a level sensing controller.

### DETAILED DESCRIPTION OF THE DRAWINGS

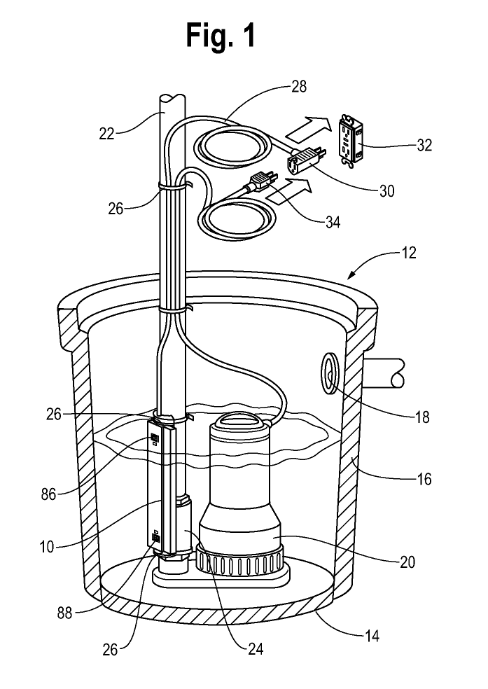

FIG. 1 illustrates a system including a level sensing controller 10. More particularly, FIG. 1 illustrates a sump 12 having a bottom 14 and a sidewall 16 for containing water and an inlet 18 though which water may enter the sump 12. A pump 20 is located on the bottom 14 of the sump 12. Pump 20 is configured to draw water from sump 12 and discharge it through a discharge pipe 22. A check valve 24 is located between discharge pipe 22 and pump 20 to prevent backflow of water from discharge pipe 22 into sump 12, for example, when discharge pipe 22 is full of water and pump 20 is turned off.

Level sensing controller 10 is attached to discharge pipe 22 and check valve 24 using tie straps 26. Alternatively, level sensing controller 10 could be attached only to discharge pipe 22, only to check valve 24, to pump 20, to sidewall 16 of sump 12, or to any other suitable structure using any suitable means, for example, threaded fasteners, u-bolts, hose clamps, tape, glue, another adhesive, epoxies, etc.

Level sensing controller 10 includes a power cord 28 having a piggyback plug 30 at its free end. Piggyback plug 30 includes a plug portion that can be plugged into an electrical outlet 32 and a receptacle portion that can receive the power plug 34 of pump 20.

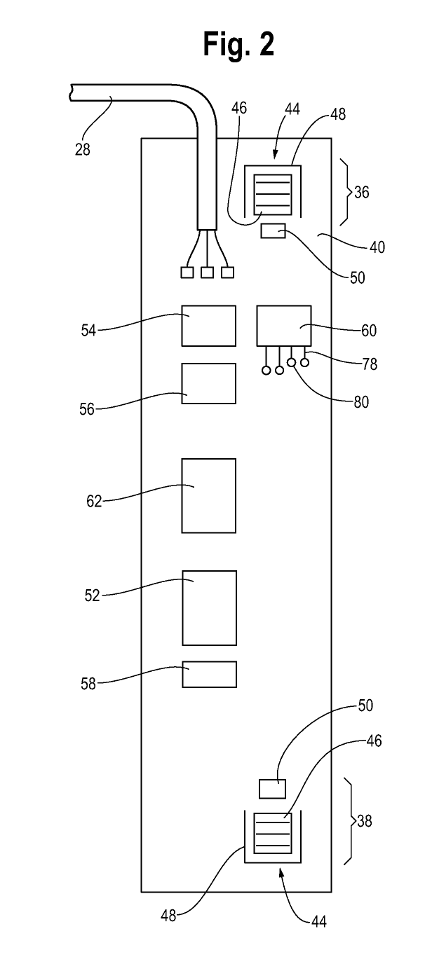

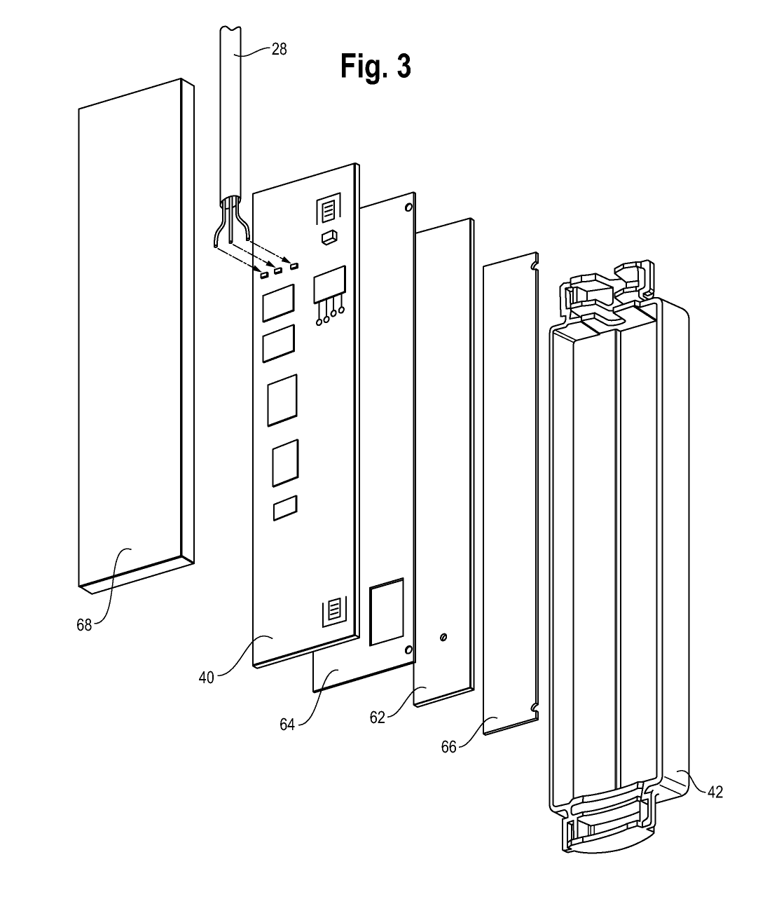

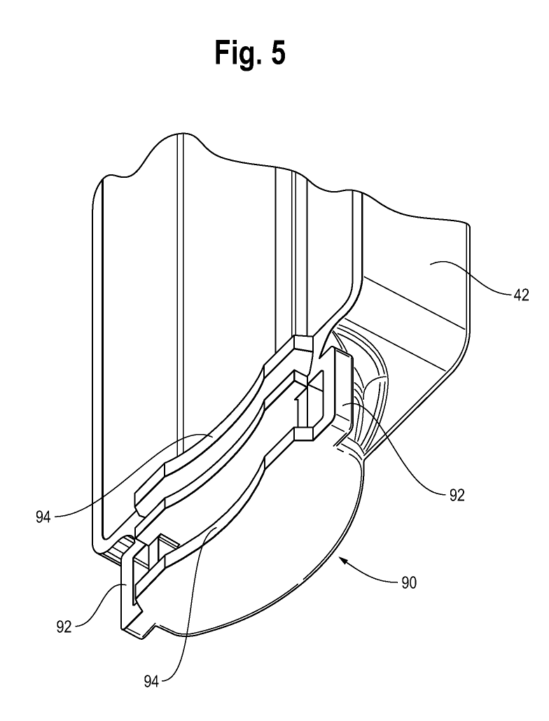

FIGS. 2-5 illustrate level sensing controller 10 in greater detail. Level sensing controller 10 includes a first proximity sensor 36, a second proximity sensor 38, a microprocessor 52 (or other logic/control means), a triac 54 (or other form of power switch), and related components and circuitry contained within a housing 42 made of plastic or other suitable material. In the illustrated embodiment, the foregoing components are disposed on a sensor board 40, which is contained within housing 42. Sensor board 40 could be embodied as a printed wiring board or another substrate suitable for use as a circuit carrier. In other embodiments, the foregoing components could be disposed on multiple substrates within the same or separate housings and electrically coupled by hardwired or wireless connections.

First proximity sensor 36 is located near a first end of sensor board 40 and housing 42, and second proximity sensor 38 is located near a second end of sensor board 40 and housing 42. In other embodiments, either or both of first and second proximity sensors 36, 38 could be located away from the ends of sensor board 40 and housing 42, although sensors 36, 38 should be spaced sufficiently apart from each other to enable operation of level sensing controller 10 as discussed below. In an exemplary embodiment, first proximity sensor 36 and second proximity sensor 38 are spaced about seven inches apart. In other embodiments, the distance between first proximity sensor 36 and second proximity sensor 38 could be greater than or less than seven inches, as might be desired for a particular application.

First and second proximity sensors 36, 38 are configured to detect the presence of water in proximity to the corresponding portions of the exterior surface of housing 40. Each of first and second proximity sensors 36, 38 is embodied as a field effect sensor including a sensing electrode pattern 44 coupled to an integral control circuit 50 via tuning resistors 74, 76. Each sensing electrode pattern 44 includes a first sensing electrode 46 in the form of a thin, conductive pad and a second, relatively narrow electrode 48 at least partially surrounding the first electrode 44. Integral control circuit 50 is embodied as a TS-100 ASIC marketed by TouchSensor Technologies, LLC of Wheaton, Ill. First sensing electrode 46 is coupled to integral control circuit 50 via first tuning resistor 74, and second sensing electrode 48 is coupled to integral control circuit 50 via second tuning resistor 76.

The principle of operation of the foregoing sensors is described in detail in U.S. Pat. No. 6,320,282, the disclosure of which is incorporated by reference. Generally, the foregoing sensors operate by generating electric fields about the sensing electrodes and by changing output state in response to certain disturbances to the electric fields. Although the particular sensors disclosed in the foregoing reference generally would not be actuated when the fields about both of their sensing electrodes are disturbed equally, as might be the case when both electrodes are “covered” by water, the sensors can in fact be made to actuate under such conditions by properly selecting the resistance of tuning resistors 74, 76. In the illustrated embodiment, first tuning resistor 74 has a resistance of 2.25 k ohms, and second tuning resistor 76 has a resistance of 1.3 k ohms. Tuning resistors 74, 76 could have other resistances in other embodiments. In alternate embodiments, other suitable sensors could be used in place of the foregoing field effect sensors.

Each of first and second proximity sensors 36, 38 provides to microprocessor 52 an output signal indicative of whether or not the respective sensor detects the presence of water in proximity to the corresponding portion of housing 42. Based on these signals and, in some embodiments, additional criteria, microprocessor 52 determines whether pump 20 should be turned on or off. For example, microprocessor 52 may require that both of first and second proximity sensors 36, 38 detect the presence of water at substantially the same time as a condition of determining that pump 20 should be turned on. Similarly, microprocessor 52 may require that both of first and second proximity sensors 36, 38 not detect the presence of water at substantially the same time as a condition of determining that pump 20 should be turned off. Microprocessor 52 may also require that both first and second proximity sensors 36, 38 respectively detect or not detect the presence of water for at least two seconds or another shorter or longer period of time as a condition of determining that pump 20 should be turned on or off. Further, microprocessor 52 could require that pump 20 be in the “off” state for at least two seconds (or a shorter or longer period of time) before enabling pump 20 to be started. Microprocessor 52 can include programming pins/pads (J1) for-in circuit programming thereof.

If microprocessor 52 determines that pump 20 should be turned on, microprocessor 52 outputs a control signal causing triac 54 to provide power to the receptacle end of piggyback plug 30 and thereby provide power to pump 20. If microprocessor 52 determines that pump 20 should be turned off, microprocessor 52 outputs a control signal causing triac 54 to withhold power from the receptacle end of piggyback plug 30 and thereby withhold power from pump 20. These control signals could be provided directly to triac 54 or to an intervening triac driver or controller, such as opto-triac driver 56 with zero crossing control.

Where provided, opto-triac driver 56 controls triac 54 so as to switch triac 54 on only when the AC line voltage entering triac 54 from the main is at or near its zero crossing. In the illustrated embodiment, microprocessor 52 causes pump 20 to start by placing pin 4 at ground and thus pulling pin 2 of opto-triac driver 56 to ground. This enables opto-triac driver 56 to switch on triac 54 when the incoming line voltage is at or near a zero crossing. This feature allows power to be applied to pump 20 in a manner that reduces inrush current to the pump's motor when the motor starts, thereby reducing stress on the motor and on triac 54. This feature also can reduce EMI. In other embodiments, other triac drivers or controllers could be used, with or without zero crossing control.

Level sensing controller 10 can include a fuse 58 to protect level sensing controller 10 from overcurrent that may result from failure of the motor in pump 20 or another connected device or connection to a device (or short circuit) drawing current in excess of the current rating of level sensing controller 10. Fuse 58 could be selected as desired for a particular application or market, or to meet applicable regulatory or code requirements. In one embodiment, fuse 58 could be rated at 15 amps. In other embodiments, fuse 58 could have a higher or lower current rating.

Level sensing controller 10 can include thermal overload protection in the form of a thermal shut down IC 60 and a heat spreader 62 made of aluminum or other suitable material configured to transfer heat from triac 54 to thermal shut down IC 60 and/or to thermal “antennae” 78 disposed on sensor board 40 and connected to thermal shut down IC 60. Heat spreader 62 could be attached to sensor board 40 using a pressure sensitive adhesive 64 or other suitable attachment means that places heat spreader 62 in close contact with thermal shutdown IC 60 and triac 54. Sensor board can include four (or more or fewer) thermal vias 80 near thermal shutdown IC 60 for conducting heat from heat spreader 62, through sensor board 40, and toward thermal “antennae” 78 disposed on sensor board 40 and connected to thermal shutdown IC 60. Thermal antennae 78 can be made of, for example, copper plated on sensor board 40 and thermal vias 80 can be internally plated with copper to enhance their heat transfer characteristics. Heat spreader 62 carries heat from triac 54 toward thermal shutdown IC 60 and/or thermal antennae 78. Where provided, thermal vias 80 help direct heat toward thermal shutdown IC 60 and/or thermal antennae 64. Thermal shut down IC 60 causes level sensing controller 10 to shut down if a predetermined temperature limit is reached or exceeded.

If level sensing controller 10 overheats due to, for example, the pump motor drawing excessive current, pin 5 of thermal overload IC 60 will be pulled low, which in turn will pull pin 6 of microprocessor 52 low. This will reset microprocessor 52 and place all I/O pins in high impedance mode, thereby disabling opto-triac driver 56 shutting off triac 53 and thereby pump 20. Thermal overload IC 60 can be configured for a 10 degree C. hysteresis. As such, once thermal overload IC 60 has tripped, microprocessor 52 will be held in reset mode until the input temperature of thermal overload IC drops 10 C.

The trip temperature could be set at 85° C. or a higher or lower temperature, as desired. The trip temperature could be determined as a function of the particular materials used for making level sensing controller 10, including housing 10, components internal thereto, and any potting or sealants that might be used to seal those components inside housing 10. In other embodiments, level sensing controller 10 could include other forms of thermal overload protection.

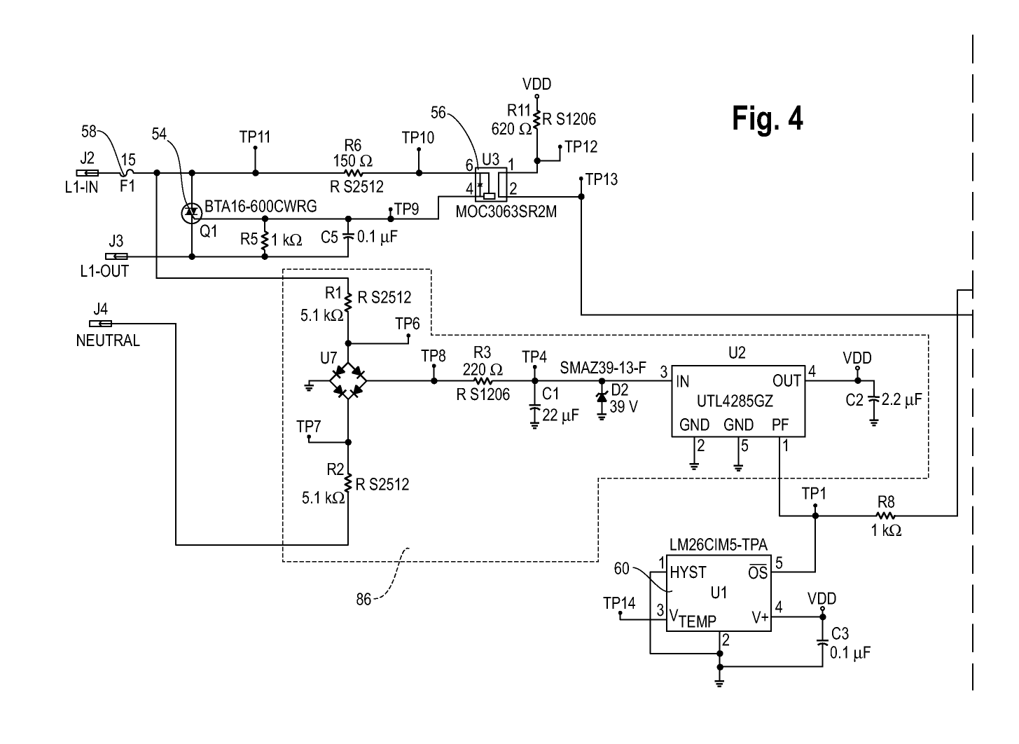

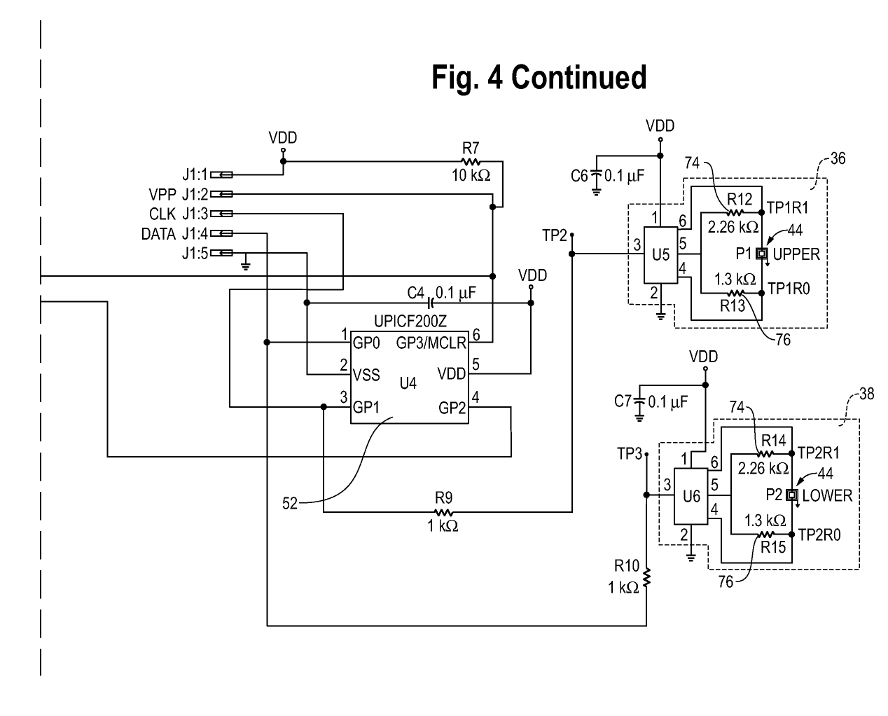

Level sensing controller 10 can include a power supply 86 to step down the input voltage, for example, 120 VAC line voltage, to a level appropriate for first and second proximity sensors 36, 38, microprocessor 40, and other components of level sensing controller 10. One form of power supply 86 is illustrated schematically in FIG. 4 and includes the components identified therein as R1, R2, R3, C1, C2, D2, U2 and U7. Power supply 86 could be embodied in forms, as well, as would be understood by one skilled in the art.

In the illustrated embodiment of power supply 86, resistors R1 & R2 reduce the line voltage before being full wave rectified by diode bridge U7. By using two resistors, one in the LINE side and one in the NEUTRAL side, a higher level of isolation can be achieved between line and low voltage DC. This helps reduce the amount of energy coupled to DC ground during high voltage line transients resulting from lighting strikes and by Electrical Fast Transients (EFT) from electrical equipment switching. These high energy transients are reduced by R1 and R2 from both LINE and NEUTRAL. R3 reduces the rectified DC voltage still further. C1 is a filter to convert rectified AC to DC.

Voltage regulator U2 then converts unregulated DC voltage to 5.0 VDC for the remaining ICs. U2 also has a power fail output pin (pin 1). If rectified DC voltage is not high enough to maintain 5.0 Volts output, Pin 1 of U2 is pulled to ground. This will in turn pull the reset line of micro-computer U4, pin 6 low thus resetting U4 and disabling the control and turning off the pump motor.

Housing 42 is illustrated as a single section having an open back, through which the foregoing electronic and other internal components of level sensing controller 10, including the terminal end of power cord 28, can be received within housing 42. Thermal pad 66 can be located between heat spreader 62 and housing 42 to protect housing 42 from thermal damage.

The internals of level sensing controller 10 can be sealed inside housing 42 in a liquid-tight manner using a suitable potting material 68, for example, an epoxy potting compound. A number of other potting materials could be used, as well. Preferably, though not necessarily, only one type of potting material would be used in a given level sensing controller 10. Achieving a liquid-tight seal around the internals of level sensing controller 10 protects the internals from water or other liquids or substances in which level sensing controller 10 might be immersed.

In other embodiments, housing 42 could include multiple sections that could be joined and sealed using gasketing, liquid sealant, sonic welding, or any other suitable sealing process. The multiple sections could be joined by, for example, a live hinge, or they could be separate pieces. Alternatively, some or all of the internals of level sensing controller 10 could be insert molded into a suitable structure, for example, the side wall of housing 42 or the side wall of a submersible pump.

The exterior of housing 42 can decorated with reference marks 86, 88 indicating the respective locations of first and second proximity sensors 36, 38 therein. These reference marks could aid an installer in determining the proper placement of level sensing controller 10 in sump 12 or another volume. Housing 42 can include mounting features such as flanges 90 and retention loops 92 for receiving tie straps 26. The rear side of flanges 90 can include contoured portions 94 to facilitate attachment of level sensing controller 10 to a curved surface, for example discharge pipe 22.

As illustrated in FIG. 1, level sensing controller 10 can be mounted vertically to maximize the vertical distance between first and second proximity sensors 36, 38 relative to sump 12 or another volume in which level sensing controller 10 might be installed. The vertical distance between first and second proximity sensors 36, 38 can be reduced by mounting level sensing controller 10 diagonally or even horizontally. In embodiments where first and second proximity sensors 36, 38 are contained in separate housings, the vertical distance between them can be adjusted by simply locating the separate housings at the desired relative heights.

In a typical installation, level sensing controller 10 is installed in a sump 12 or other volume with one of first and second proximity sensors 36, 38 at a higher level than the other. When level sensing controller is initially powered up, triac 54 is in the “off” state. If the water level in sump 12 is below the lower proximity sensor and, therefore, the upper proximity sensor, neither sensor detects the presence of water. This condition is reflected in the outputs of the sensors, which outputs are provided to microprocessor 52. Because neither sensor detects the presence of water, microprocessor 52 outputs a signal to triac 54 indicating that triac 54 should not provide power to pump 20. In response, triac 54 remains in the “off” state.

As the water level rises in sump 12, it first will rise to or above the level of the lower sensor. When the water level rises to or above the level of the lower sensor, the output of the lower sensor changes state to indicate the presence of water there. The upper sensor is unaffected. With pump 20 initially off and only the lower sensor providing an output indicating the presence of water there, microprocessor 52 outputs a signal to triac 54 indicating that triac 54 should not provide power to pump 20. In response, triac 54 remains in the “off” state.

As the water level continues to rise in sump 12, it eventually will rise to or above the level of the upper sensor. When the water level rises to or above the level of the upper sensor, the output of the upper sensor changes state to indicate the presence of water there. With both the lower sensor and upper sensor providing outputs indicating the presence of water there, microprocessor 52 outputs a signal to triac 54 indicating that triac 54 should provide power to pump 20. In response, triac 54 switches to the “on” state, providing power to the receptacle end of piggyback plug 30 and to pump 20, thereby causing pump 20 to start. In some embodiments, microprocessor 52 could be configured to delay the pump start signal for a predetermined time (for example, two seconds or a shorter or longer period of time) after the rising water has risen to or covered both the upper and lower sensors.

With pump 20 running, the water level in sump 12 begins to fall. Initially, the upper sensor becomes exposed while the lower sensor continues to be covered by water. Once the upper sensor becomes exposed, the output of the upper sensor again changes state to indicate that water is no longer present there. With pump 20 running, the upper sensor exposed, and the lower sensor still covered by water, microprocessor 52 continues to provide an output signal to triac 54 indicating that triac 54 should provide power to pump 20. As such, pump 20 continues to run.

As the water level continues to fall, it eventually exposes the lower sensor. Once the lower sensor becomes exposed, the output of the lower sensor again changes state to indicate that water is no longer present there. With pump 20 running, the upper sensor exposed, and the lower sensor also exposed, microprocessor 52 outputs a signal to triac 54 indicating that triac 54 should withhold power from pump 20. In response, triac 54 switches to the “off” state, withholding power from the receptacle end of piggyback plug 30 and from pump 20, thereby causing pump 20 to stop. In some embodiments, microprocessor 52 could be configured to delay the pump stop signal for a predetermined time (for example, one second or a shorter or longer period of time) after the falling water has exposed both the upper and lower sensors.

As water reenters sump 12, the foregoing cycle repeats. In some embodiments, microprocessor 52 could delay a further pump start signal until triac 54 and therefore pump 20 has been switched off for a predetermined time (for example, two seconds or a shorter or longer period of time).

The pump start and stop level setpoints could be adjusted by simply rotating level sensing controller 10 from a vertical to a diagonal position, thereby decreasing the vertical distance between the upper and lower sensors. In some embodiments, for example, a swimming pool cover pump application where the fluid level does not change much between the pumped out and filled states, level sensing controller 10 could be mounted substantially horizontally.

The foregoing disclosure describes certain exemplary embodiments of, applications for, and methods of using, a level sensing controller. Those skilled in the art would recognize that these exemplary embodiments, applications and methods could be altered or modified without deviating from the scope of the invention as determined by proper construction of the appended claims.

1. An apparatus for sensing level of a substance in a volume, comprising:
a first proximity sensor adapted to sense, and output a signal indicative of, the proximity of a substance;
a second proximity sensor adapted to sense, and output a signal indicative of, the proximity of said substance, said second proximity sensor spaced apart from said first proximity sensor;
a control circuit coupled to and adapted to receive said signals from said first proximity sensor and said second proximity sensor;
said control circuit further adapted to output at least one control signal, said at least one control signal indicative of whether both of said first and second proximity sensors sense the proximity of said substance or neither of said first and second proximity sensors sense the proximity of said substance.

2. The apparatus of claim 1 wherein said first proximity sensor is contained within a first water tight enclosure.

3. The apparatus of claim 2 wherein said second proximity sensor is contained within said first water tight enclosure or within a second water tight enclosure.

4. The apparatus of claim 3 wherein said control circuit is contained within said first water tight enclosure, said second water tight enclosure, or a third water tight enclosure.

5. The apparatus of claim 1 wherein said first and second proximity sensors and control circuit are coupled by a hard connection.

6. The apparatus of claim 1 wherein said first and second proximity sensors and control circuit are coupled by a wireless connection.

7. The apparatus of claim 1 wherein said first and second proximity sensors and control circuit are contained within a water tight enclosure.

8. The apparatus of claim 1 in combination with said volume.

9. The apparatus of claim 8 wherein said volume is a vessel or container.

10. The apparatus of claim 9 wherein said volume is a sump pit.

11. The apparatus of claim 8 wherein said volume is a pool cover.

12. The apparatus of claim 1 in combination with means for conveying said substance.

13. The apparatus of claim 12 wherein said means for conveying said substance is a conveyor.

14. The apparatus of claim 12 wherein said means for conveying said substance is a pump.

15. The apparatus of claim 1 wherein said substance is a powder.

16. The apparatus of claim 1 wherein said substance is a liquid.

17. The apparatus of claim 1 wherein said control circuit is located in a first housing and at least one of said first and second proximity sensors is located in a second housing.

18. The apparatus of claim 17 wherein said control circuit is coupled to said one of said first and second proximity sensors located in said second housing.

19. The apparatus of claim 18 wherein said coupling is via a tether connecting said first housing and said second housing.

20. The apparatus of claim 18 wherein said coupling is wireless.

21. The apparatus of claim 1 wherein said first and second proximity sensors are located in a housing, wherein said housing is oblong, and wherein said first and second proximity sensors are spaced apart along the length of said oblong housing.

22. The apparatus of claim 21 wherein said oblong housing is associated with said volume in either of two substantially vertical orientations.

23. The apparatus of claim 21 wherein said oblong housing is associated with said volume in a substantially diagonal orientation.

24. The apparatus of claim 21 wherein said oblong housing is associated with said volume in a substantially horizontal orientation.

25. The apparatus of claim 1 in combination with an electrical contactor wherein said control signal controls pick up and drop out of said contactor.

26. The apparatus of claim 1 further comprising a third proximity sensor coupled to said control circuit.

27. The apparatus of claim 26 wherein said third proximity sensor is located to sense escape of said substance from said volume.

28. The apparatus of claim 1 in combination with a municipal sewer system.

29. A method controlling the level of a substance in a volume comprising the steps of:
providing an apparatus as set forth in claim 1;
positioning said apparatus in said volume;
providing conveying means for conveying said substance;
coupling said apparatus to said conveying means;
wherein said apparatus causes said conveying means to convey said substance after said first and second proximity sensors have substantially simultaneously sensed proximity of said substance for at least a predetermined time; and
wherein said apparatus causes said conveying means to cease conveying said substance after said first and second proximity sensors have substantially simultaneously not sensed proximity of said substance for at last a predetermined time.

30. The method of claim 29 wherein said predetermined time is between 0 seconds and infinity.

31. The method of claim 29 wherein said apparatus causes said conveying means to convey only after a predetermined time delay, said predetermined time delay being independent of said predetermined time during which said first and second proximity sensors have substantially simultaneously sensed proximity of said substance.

32. The method of claim 29 wherein said apparatus causes said conveying means to cease conveying only after a predetermined time delay.
